(19) United States
(12) Patent Application Publication
(10) Pub. No.: US 2012/0182855 A1
(43) Pub. Date: Jul. 19, 2012

(54) Objective Lens and Optical Pickup Device

(75) Inventor: Shogo Yamamoto, Shinjuku-ku (JP)

(73) Assignee: Konica Minolta Opto, Inc., Tokyo (JP)

(21) Appl. No.: 13/498,537

(22) PCT Filed: Aug. 24, 2010
(86) PCT No.: PCT/JP2010/064226

§ 371 Date: Mar. 27, 2012

(30) Foreign Application Priority Data
Sep. 30, 2009 (JP) 2009-227876

(51) Int. Cl. G11B 7/1374; G02B 3/00

(52) U.S. Cl. 369/112.23; 359/642; G9B/7.121

(57) ABSTRACT

Provided is an objective lens that enables the suppression of molding defects in a high NA lens, and an optical pickup device. As the objective lens (OBJ) includes a thick-flange section (FT), a thick-flange-section forming section (11c) can be formed on a first-flange-section transfer surface (11b) of a first mold (10) so as to connect to a gate section (GT), as shown in FIG. 2. Thereby, the cross sectional area of the gate section (GT) is increased, which allows optimizing the gate seal time, applying sufficient pressure, and effectively removing air.

### TECHNICAL FIELD

The present invention relates to an objective lens. Especially, the present invention relates to an objective lens with a NA of 0.75 or more, suitable for use in an optical pickup device, and relates to an optical pickup device.

### BACKGROUND ART

High-density optical disc systems which can record and/or reproduce (hereinafter, “record and/or reproduce” will be represented as “record/reproduce”) information by using a blue-violet semiconductor laser of wavelength of about 400 nm have already come onto the market. For an example, as for an optical disc on which information is recorded/reproduced according to the specifications of a NA of 0.85 and a light-source wavelength of 405 nm, namely a Blu-ray Disc (hereinafter, represented as BD), information of 23 to 27 GB per layer can be recorded for an optical disc with a diameter of 12 cm which is the same size as a DVD (NA: 0.6, light-source wavelength: 650 nm, storage capacity: 4.7 GB).

When objective lenses for use in optical pickup devices are formed by a molding process, they can be mass-produced and can be reduced in cost. Patent Literature 1 discloses a technique to produce a plastic lens by a so-called injection molding, which is a technique to form a cavity corresponding to a lens by using molds and to pour molten plastic resin into the cavity through a resin inflow entrance called as a gate to form a lens.

### CITATION LIST

### Patent Literature

Patent Literature 1: JP-A No. 2005-84080

### SUMMARY OF INVENTION

### Technical Problem

In an objective lens for use in a conventional optical pickup device for DVDs, since its NA is about 0.6, the axial thickness of the lens is relatively thin compared with the flange thickness and the objective lens can be produced by the injection molding technique disclosed in Patent Literature 1. However, in an objective lens for use in an optical pickup apparatus for BDs, since its NA is about 0.75, the axial thickness of the lens is relatively thick compared with the flange thickness and the objective lens has a shape close to a hemisphere, which increases the total amount of resin which is injected into a cavity. Under the condition that the total amount of resin increases, when resin is poured in a cavity through a narrow gate, the gate is sealed before a pressure is sufficiently transmitted to the maximum thickness part in the cavity. Therefore, air in the cavity is difficult to be pushed out, which results in air pockets and causes a defect that a desired optical surface cannot be obtained. To solve that, by increasing the flange thickness as a whole, the gate also becomes thick and the pressure can be sufficiently transmitted. However, it causes a problem that the weight increases, which is disadvantageous for a tracking and focusing operations of the objective lens. Further, when the axial lens thickness is increased with a increase of the flange thickness as a whole, it causes a reduction of a working distance which works for avoiding the lens from touching an optical disc, which is a problem.

The present invention has been achieved to solve the above problems of the conventional art, and is aimed to provide an objective lens and an optical pickup device which can control defects generated when a lens with a high NA is molded.

### Solution to Problem

An objective lens described in claim 1 is an objective lens for use in an optical pickup device which records and/or reproduces information by converging a light flux with a wavelength of 500 nm or less onto an information recording surface of an optical disc. The objective lens is characterized in that the objective lens has a NA of 0.75 or more, and the objective lens comprises optical surfaces and a flange section surrounding the optical surfaces, wherein a part of the flange section forms a thick-flange section whose thickness in an optical axis direction is thicker than a thickness of the rest of the flange section. The objective lens is characterized in that the thick-flange section protrudes more than a maximum effective aperture toward an optical axis, when the objective lens is viewed from the optical axis direction, and the objective lens satisfies the following expression.

0.9≦d/f≦1.2 (1)

In the expression, d(mm) is an axial thickness of the objective lens, and f(mm) is a focal length of the objective lens for the light flux with the wavelength of 500 nm or less.

According to the present invention, a part of the flange section forms a thick-flange section whose thickness in an optical axis direction is thicker than a thickness of the rest of the flange section, and the thick-flange section protrudes more than a maximum effective aperture toward an optical axis, when the objective lens is viewed along the optical axis direction. The thickness of the gate can be increased by providing the gate through a thick-flange-section forming section which corresponds to the thick-flange section and has a relatively large sectional area. By pouring a material of the objective lens from the gate into the mold, pressure which is sufficient for clearing the air in the cavity out from the cavity smoothly can be applied even in an objective lens with an axial thickness as large as that for use in an optical pickup device for BDs, and accurate optical surfaces can be molded. Further, because the thickness of the flange section excluding the thick-flange section is same as that of the conventional art, an increase of the weight can be restricted to be the minimum. Since the thickness of the flange section excluding the thick-flange section can be restricted, the axial thickness of the lens is not required to be increased. As the result, the thickness of the flange section excluding the thick-flange section can be reduced to be a small value. Therefore, it does not cause a possibility that the working distance decreases.

An objective lens described in claim 2 is an objective lens for use in an optical pickup device which records and/or reproduces information by converging a light flux with a wavelength of 500 nm or less onto an information recording surface of an optical disc. The objective lens is characterized in that the objective lens has a NA of 0.75 or more, and the objective lens comprises optical surfaces and a flange section surrounding the optical surfaces, wherein the flange section comprises a ring-shaped section extending in a direction of a circumference thereof, on at least one of surfaces ranging in the optical axis direction. The objective lens is characterized in that the ring-shaped section is split by a thick-flange section which is formed to range from the flange section to one of the optical surfaces, and the objective lens satisfies the following expression.

0.9≦d/f≦1.2 (1)

In the expression, d(mm) is an axial thickness of the objective lens, and f(mm) is a focal length of the objective lens for the light flux with the wavelength of 500 nm or less.

According to the present invention, the flange section includes a ring-shaped section extending in a direction of a circumference thereof, on at least one of surfaces ranging in the optical axis direction. Further, the ring-shaped section is split by a thick-flange section which is formed to range from the flange section to one of the optical surfaces. The thickness of the gate can be increased by providing the gate through a thick-flange-section forming section which corresponds to the thick-flange section and has a relatively large sectional area. By pouring a material of the objective lens from the gate into the mold, pressure which is sufficient for clearing the air in the cavity out from the cavity smoothly can be applied even in an objective lens with an axial thickness as large as that for use in an optical pickup device for BDs, and accurate optical surfaces can be molded. Further, because the thickness of the flange section excluding the thick-flange section is same as that of the conventional art, an increase of the weight can be restricted to be the minimum. Since the thickness of the flange section excluding the thick-flange section can be restricted, the axial thickness of the lens is not required to be increased. As the result, the thickness of the flange section excluding the thick-flange section can be reduced to be a small value. Therefore, it does not cause a possibility that the working distance decreases.

An objective lens described in claim 3 is the objective lens of claim 2, characterized in that the flange section comprises a groove extending in the direction of the circumference thereof on at least one of surfaces ranging in the optical axis direction, and the groove is split by the thick-flange section.

An objective lens described in claim 4 is the objective lens of claim 2 or 3, characterized in that the ring-shaped section is formed on a surface closer to an optical surface with a smaller curvature radius than the other among the optical surfaces.

An objective lens described in claim 5 is the objective lens of any one of claims 1 to 4, characterized in that the thick-flange section is arranged around a gate.

An objective lens described in claim 6 is the objective lens of any one of claims 1 to 5, characterized by satisfying the following expression.

2.0≦d/Δ≦5.0 (2)

In the expression, Δ(mm) is a thickness of the thick-flange section.

An objective lens described in claim 7 is the objective lens of any one of claims 1 to 6, characterized by satisfying the following expression.

5.0<d/t≦8.0 (3)

In the expression, t(mm) is a minimum thickness of the flange section.

An objective lens described in claim 8 is the objective lens of any one of claims 1 to 6, characterized in that the objective lens is formed of a resin material.

An image pickup device described in claim 9 is an optical pickup device characterized by comprising the objective lens of any one of claims 1 to 8. The optical pickup device comprises a light source for emitting a light flux with a wavelength of 500 nm or less, a light-converging optical system including the objective lens, and a photodetector. The light-converging optical system may comprise a coupling lens such as a collimator, additionally to the objective lens.

In the present specification, an objective lens means an optical system which is arranged at a position to face an optical disc in an optical pickup device and has a function to converge a light flux emitted from a light source onto an information recording surface of an optical disc. The objective lens is preferably a single lens. The objective lens may be a glass lens, a plastic lens or a hybrid lens in which an optical path difference providing structure formed of a material such as photo-curable resin, UV-curable resin and thermosetting resin is formed on a glass lens. An optical path difference providing structure may be formed on a plastic lens to be one body. In the objective lens, a refractive surface is preferably an aspheric surface. Further, the objective lens preferably has an aspheric base surface on which an optical path difference providing structure is provided. The optical pickup device preferably uses at least a light source (such as a semiconductor laser) of wavelength of 500 nm or less (preferably, 350 nm or more, and 450 nm or less). The objective lens has a numerical aperture at the image side of 0.75 or more (preferably, 0.75 or more, and 0.9 or less). The objective lens includes optical surfaces and a flange section. The flange section is a part which includes a ring-shaped section extending in the direction almost perpendicular to the optical axis, surrounding an optical surface and which is used for supporting the objective lens. The ring-shaped section of the flange section is cut and split in the circumference direction by the thick-flange section. In the present specification, the thickness of the flange section and the thickness of the thick-flange section represent thicknesses measured in the optical axis direction.

Further, when a plastic lens is employed for the objective lens, it is preferable that alicyclic hydrocarbon polymers such as a resin material in a cyclic olefin group are used for the objective lens. As the resin material, there is more preferably used a resin material having: a refractive index at the temperature 25° C. for wavelength 405 nm, which is within the range of 1.50 to 1.60; and a ratio of refractive index change dN/dT (° C.⁻¹) caused by a temperature change within the temperature range of −5° C. to 70° C. for the wavelength 405 nm, which is within the range of −20×10⁻⁵ to −5×10⁻⁵ (more preferably, −10×10⁻⁵ to −8×10⁻⁵).

The objective lens preferably satisfies the following expression (1).

0.9≦d/f≦1.2 (1)

In the expression, d(mm) is an axial thickness of the objective lens, and f(mm) is a focal length of the objective lens for the light flux with the wavelength of 500 nm or less.

The objective lens more preferably satisfies the following expression.

0.9≦d/f≦1.1 (1′)

When the objective lens handles an optical disc with a high NA using a short wavelength such as a BD, there is caused a problem that astigmatism is easily generated and decentration coma is easily generated, in the objective lens. However, when the conditional expressions (1) or (1′) is satisfied, a long working distance can be secured while generation of the astigmatism and decentration coma is controlled.

It is preferable that the following expression is satisfied, where Δ(mm) is a thickness of the thick-flange section.

2.0d/Δ≦5.0 (2)

It is preferable that the following expression is satisfied, where t(mm) is a minimum thickness of the thick-flange section.

5.0≦d/t≦8.0 (3)

### Advantageous Effect of Invention

According to the present invention, an objective lens which can restricts defects generated when a lens with a high NA is molded can be provided.

### BRIEF DESCRIPTION OF DRAWINGS

FIG. 1 is a diagram illustrating the steps of molding an objective lens relating to the present embodiment by using a mold.

FIG. 2 is an enlarged view of the mold for molding the objective lens relating to the present embodiment.

FIG. 3 is an enlarged view of the mold for molding the objective lens relating to a comparative example.

FIG. 4a is a diagram showing objective lens OBI relating to the present embodiment, viewed from the optical axis direction, and FIG. 4b is a diagram showing the objective lens OBI viewed from the direction perpendicular to the optical axis.

FIG. 5a is a diagram showing objective lens OBJ relating to the comparative example, viewed from the optical axis direction, and FIG. 5b is a diagram showing the objective lens OBJ viewed from the direction perpendicular to the optical axis.

FIG. 6a is a diagram showing objective lens OBI relating to another embodiment, viewed from the optical axis direction, and FIG. 6b is a diagram showing the objective lens OBI of FIG. 6a cut along line VIB-VIB and viewed from the direction of the arrows.

### DESCRIPTION OF EMBODIMENTS

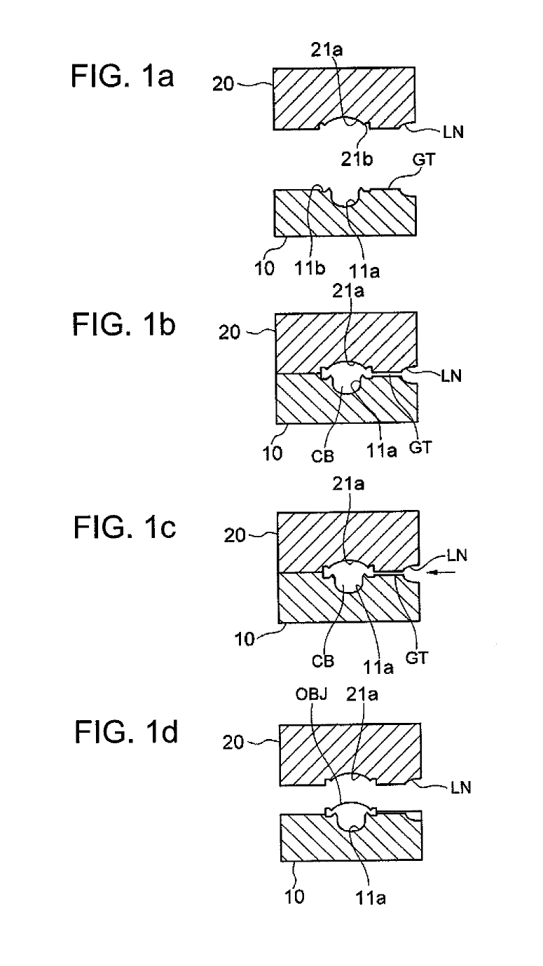

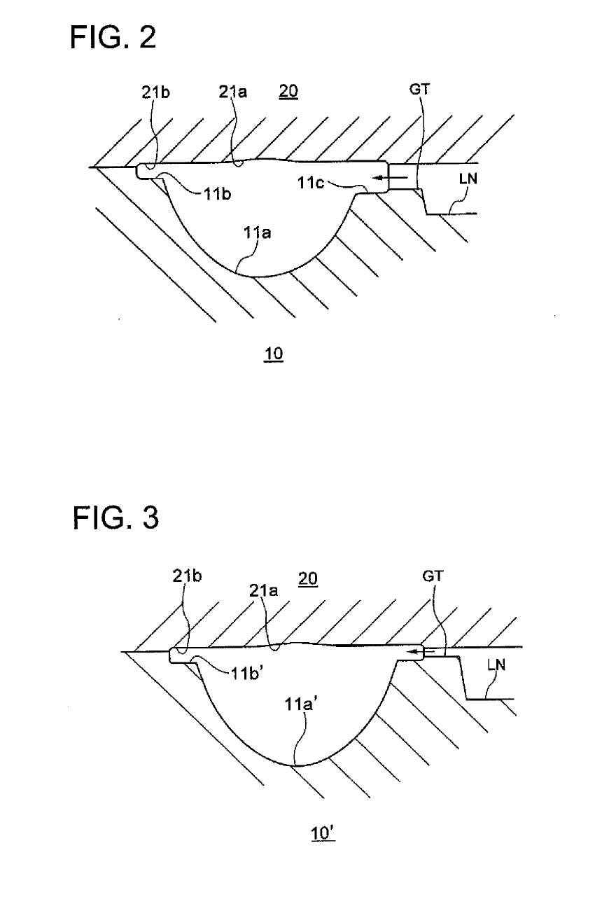

Referring to the drawings, the embodiments of the present invention will be described below. FIG. 1 is a diagram illustrating the steps of molding the objective lens with a NA of 0.85 for use in an optical pickup device for BDs, by using a mold. FIG. 2 is an enlarged view of the mold relating to the present embodiment. A mold includes first mold 10 and second mold 20 and has a structure that plural cavities are formed under the condition that the both molds are clamped together. In FIG. 1, the form of the cavity is schematically represented. Illustration of an optical pickup device is omitted, because it is enough to use a common optical pickup device.

As shown in FIG. 2, first mold 10 includes first-optical-surface transfer surface 11a for transferring and molding the first optical surface of the objective lens (which faces the light-source side when the objective lens is mounted on the optical pickup device) and first-flange-section transfer surface 11b connecting with the circumference of the first-optical-surface transfer surface, for transferring and molding the light-source side surface (ring-shaped section) of the flange section. On first mold 10, there is further formed gate section (entrance channel) GT so as to connect with first-flange-section transfer surface 11b. In first-flange-section transfer surface 11b, thick-flange-section forming section 11c, which looks like as the first-flange-section transfer surface is sunk partially along the circumference, is formed so as to connect with gate section GT.

On the other hand, second mold 20 includes second-optical-surface transfer surface 21a for transferring and molding the second optical surface of the objective lens (which faces the optical-disc side when the objective lens is mounted on the optical pickup device) and second-flange-section transfer surface connecting with the circumference of the second-optical-surface transfer surface, 21b for transferring and molding the optical-disc side surface of the flange section.

FIG. 3 is a sectional view of the objective lens relating to a comparative example, which is similar to FIG. 2. In the mold of a comparative example, the second mold 20 has the same shape, but is different in the point that, in first mold 10′, first-flange-section transfer surface 11b does not include thick-flange-section forming section 11c and has a uniform thickness in whole in circumference. In other words, the ring-shaped section of the flange section does not split by a thick-flange section.

Next, a method of producing an objective lens relating to the present embodiment will be described. First, as shown in FIG. 1a, first mold 10 is set to face second mold 20. Then, first mold 10 and second mold 20 are heated by an unillustrated heater to heat optical-surface transfer surfaces 11a and 21a to a predetermined temperature.

After that, as shown in FIG. 1b, first mold 10 is arranged relatively close to second mold 20 and the condition that they tightly touch each other is achieved. After they are clamped together under a predetermined pressure, resin which is heated to a higher temperature than the mold temperature is fed from an unillustrated nozzle through runner LN and gate section GT, under the condition that tan arbitral pressure is applied to the resin (see FIG. 1c).

Next, molten resin is kept waiting for a predetermined time until the resin is solidified with the forms of transfer surfaces 11a, 11b, 21a and 21b and the forms of thick-flange-section forming section 11c transferred thereon, then the resin is cooled.

After that, when first mold 10 and second mold 20 are relatively moved and the molds are opened, a molded body including objective lens OBJ is exposed with sticking to first mold 10. By separating objective lens OBJ from the molded body, objective lens OBJ as an individual body is formed.

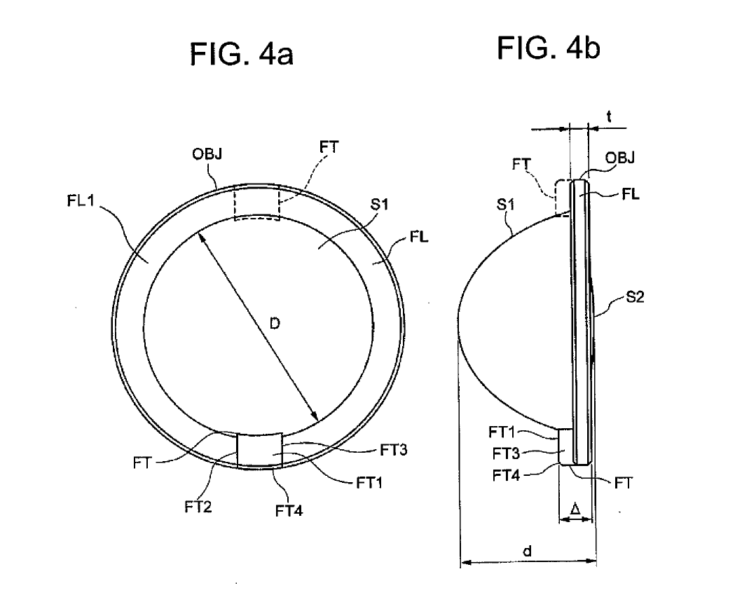

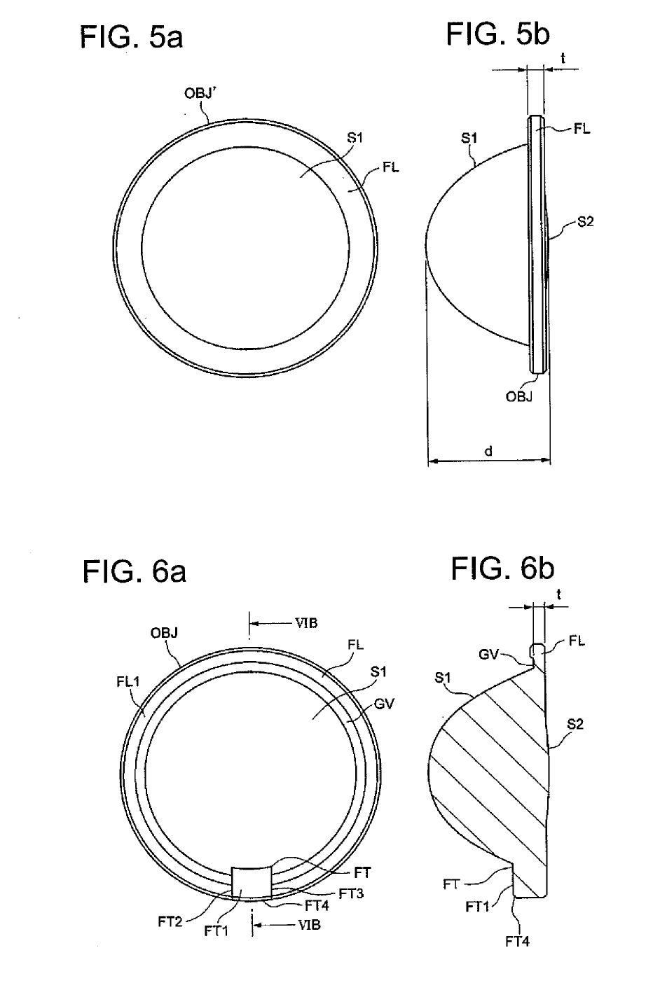

FIG. 4 is a diagram showing objective lens OBJ molded with the mold shown in FIG. 2 and FIG. 5 is a diagram showing objective lens OBJ′ molded with the mold shown in FIG. 3. In objective lens OBJ′ as a comparative example shown in FIG. 5, thickness t of flange section FL in the optical axis direction is uniform in the whole circumference. In other words, it has a shape that the ring-shaped section of flange section FL is not split by the thick-flange section. In order to decrease the weight and increase the working distance, it is preferable to make ratio (d/f) which is the ratio of axial lens thickness d to focal length f of objective lens OBJ′, 1.2 or less, which makes thickness t excessively thin and deteriorates a filling factor of resin. Therefore, an accurate optical surface is hardly formed.

On the other hand, in objective lens OBJ of the present embodiment shown in FIG. 4, a part of flange section is formed into thick-flange section FT. In other words, ring-shaped section FL1 of flange section FL (the surface at the side of first optical surface S1) is split by thick-flange section FT. More concretely, objective lens OBJ includes first optical surface S1 transferred and molded by first-optical-surface transfer surface 11a; second optical surface S2 with curvature radius being greater than that of first optical surface S1, transferred and molded by second-optical-surface transfer surface 21a; flange section FL transferred and molded by fast-flange-section transfer surface 11b and second-flange-section transfer surface 21b; and thick-flange section FT transferred and molded by thick-flange-section forming section 11c such that flange section FL partially protrudes toward first optical surface S1. Thick-flange section FT includes light-source-side surface FT1 extending in the direction perpendicular to the optical axis, parallel surfaces FT2 and FT3 perpendicular to light-source-side surface FT1, and chamfered surface FT4 formed at the edge of light-source-side surface FT1. Light-source-side surface FT1 touches with first optical surface S1 within the effective aperture. Because they touch within the effective aperture, the thickness of thick-flange section FT can be increased and a pressure loss caused when the resin is poured can be reduced.

In the embodiment, the following expressions are satisfied, where d(mm) is an axial thickness of objective lens OBJ, f(mm) is a focal length of objective lens OBJ for a light flux with the wavelength of 500 nm or less, Δ(mm) is a thickness of thick-flange section FT of objective lens OBJ, and t(mm) is the minimum thickness of flange section FL (excluding thick-flange section FT).

0.9≦d/f≦1.2 (1)

2.0≦d/Δ≦5.0 (2)

5.0<d/t≦8.0 (3)

According to the present embodiment, objective lens OBJ includes thick-flange section FT in flange section FL. Therefore, as shown in FIG. 2, there can be provided a structure that thick-flange-section forming section 11c can be formed on first-flange-section transfer surface 11b of first mold 10 such that thick-flange-section forming section 11e is connected to gate section GT. Thereby, gate-seal time is optimized by increasing the sectional area of gate section GT, a sufficient pressure can be applied and the air is removed efficiently. When a groove for removing air, called as an air bent, is arranged between first mold 10 and second mold 20, the air remaining in the cavity is leaked in a injection molding process, which avoids generation of air pockets in the cavity and allows the resin to tightly touch with the transfer surfaces with accuracy. When the air is sucked out through the air bent with a suction pump from the outside, the air removing property is more enhanced.

Herein, for convenience of the mold processing, thick-flange section FT has a shape that thick-flange section FT protrudes from the diameter of maximum effective aperture D of first optical surface S1 toward the optical axis and is unified with first surface S1 as one body, when objective lens OBJ is viewed from the optical axis direction, as shown in FIG. 4. As the result, it blocks a part of light which is converged onto an optical disc. However, when the above conditional expression (2) is satisfied, the area blocked by thick-flange section FT becomes small in comparison with the total effective area of the optical surface, and the amount of blocked light does not cause a problem in particular.

There is provided one thick-flange section FT in the present embodiment, but there may be provided plural thick-flange sections. In this case, when they are arranged at symmetric positions across the optical axis as shown in the dotted line in FIG. 4, the lens is in a well-balanced condition and the position of the center of gravity is located on the optical axis, which is especially effective when objective lens OBJ is driven for tracking and focusing control.

FIG. 6 is a diagram showing objective lens OBJ relating to another embodiment. In the present embodiment, flange section FL includes groove GV on ring-shaped section FL1, located at the side of first optical surface S1. The groove extends in the circumference direction. Ring-shaped section FL1 and groove GV of flange section FL are split by thick-flange section FT which is formed so as to range from flange section FL to first optical surface S1. Therefore, in the present embodiment, minimum thickness t of flange section FL is measured at the bottom section of groove GV. Groove GV may be formed at the side of second optical surface S2. The descriptions of the other structures (including the relationship to the expressions (1) to (3)) are omitted because they are same as the above embodiment.

The present invention has been described referring with the embodiments. It is to be understood that the present invention is not limited to the above embodiments, and that various changes and modifications will be apparent to those skilled in the at

### REFERENCE SIGNS LIST

OBJ Objective lens
FL Flange section
FL1 Ring-shaped section
FT Thick-flange section
S1 First optical surface
S2 First optical surface
GV Groove

1. An objective lens for use in an optical pickup device which records and/or reproduces information by converging a light flux with a wavelength of 500 nm or less onto an information recording surface of an optical disc,
wherein the objective lens has a NA of 0.75 or more,
the objective lens comprises optical surfaces and a flange section surrounding the optical surfaces, wherein a part of the flange section forms a thick-flange section whose thickness in an optical axis direction is thicker than a thickness of the rest of the flange section,
the thick-flange section protrudes more than a maximum effective aperture of the objective lens toward an optical axis, when the objective lens is viewed from the optical axis direction, and
the objective lens satisfies the following expression:
0.9≦d/f≦1.2 (1)
where d(mm) is an axial thickness of the objective lens, and
f(mm) is a focal length of the objective lens for the light flux with the wavelength of 500 nm or less.

2. An objective lens for use in an optical pickup device which records and/or reproduces information by converging a light flux with a wavelength of 500 nm or less onto an information recording surface of an optical disc,
wherein the objective lens has a NA of 0.75 or more,
the objective lens comprises optical surfaces and a flange section surrounding the optical surfaces, wherein the flange section comprises a ring-shaped section extending in a direction of a circumference thereof, on at least one of surfaces ranging in the optical axis direction,
the ring-shaped section is split by a thick-flange section which is formed to range from the flange section to one of the optical surfaces, and
the objective lens satisfies the following expression:
0.9≦d/f≦1.2 (1)
where d(mm) is an axial thickness of the objective lens, and
f(mm) is a focal length of the objective lens for the light flux with the wavelength of 500 nm or less.

3. The objective lens of claim 2,
wherein the flange section comprises a groove extending in the direction of the circumference thereof, on at least one of surfaces ranging in the optical axis direction, and
the groove is split by the thick-flange section.

4. The objective lens of claim 2
wherein the ring-shaped section is formed on a surface closer to an optical surface with a smaller curvature radius than the other among the optical surfaces, out of the surfaces ranging in the optical axis direction of the flange section.

5. The objective lens of claim 1,
wherein the thick-flange section is arranged around a gate.

6. The objective lens of claim 1, satisfying the following expression:
2.0≦d/Δ≦5.0 (2)
where Δ(mm) is a thickness of the thick-flange section.

7. The objective lens of claim 1, satisfying the following expression:
5.0<d/t≦8.0 (3)
where t(mm) is a minimum thickness of the flange section.

8. The objective lens of claim 1,
wherein the objective lens is formed of a resin material.

9. An optical pickup device comprising the objective lens of claim 1.

10. The objective lens of claim 2,
wherein the thick-flange section is arranged around a gate.

11. The objective lens of claim 2, satisfying the following expression:
2.0≦d/Δ≦5.0 (2)
where Δ(mm) is a thickness of the thick-flange section.

12. The objective lens of claim 2, satisfying the following expression:
5.0<d/t≦8.0 (3)
where t(mm) is a minimum thickness of the flange section.

13. The objective lens of claim 2,
wherein the objective lens is formed of a resin material.

14. An optical pickup apparatus comprising the objective lens of claim 2.
